(19) United States
(12) Patent Application Publication
(10) Pub. No.: US 2022/0224182 A1
(43) Pub. Date: Jul. 14, 2022

(54) STATOR WINDING ARRANGEMENT HAVING MULTIPLE PARALLEL PATHS

(71) Applicant: BorgWarner Inc., Auburn Hills, MI (US)

(72) Inventors: Kirk Neet, Noblesville, IN (US); Tausif Husain, Carmel, IN (US); Micah Andrew Jones, Warren, IN (US)

(21) Appl. No.: 17/545,929

(22) Filed: Dec. 8, 2021

Related U.S. Application Data
(60) Provisional application No. 63/122,898, filed on Dec. 8, 2020.

(51) Int. Cl. H02K 3/52; H02K 3/28; H02K 5/22; H02K 1/16

(52) U.S. Cl. CPC H02K 3/522; H02K 3/28; H02K 2203/09; H02K 1/16; H02K 5/225

(57) ABSTRACT

A method and arrangement is disclosed herein for making a stator winding with extended legs that may be selectively configured in a four parallel path per phase arrangement or a six parallel path per phase arrangement.

### CROSS-REFERENCE TO RELATED APPLICATIONS

The present application claims priority from U.S. Provisional Patent Application Ser. No. 63/122,898, filed Dec. 8, 2020, the entire contents of which are incorporated herein by reference.

### FIELD

The present disclosure relates to the field of electric machines, and more particularly, stator winding arrangements and connections for such winding arrangements.

### BACKGROUND

Electric machines are designed to meet specific operating requirements based on the intended application the electric machine. For example, in vehicle applications, some electric machines are specifically adapted for use in heavy-duty vehicles while other electric machines are differently adapted for use in light-duty/passenger. Different electric machines designs will have different operating performance characteristics. Examples of design features that contribute to operating performance include stator size, rotor size, torque output, efficiency, type and arrangement of the of windings, number of stator slots, number of poles, slots per pole per phase, number of conductors per slot, number of parallel paths per phase, number of turns, and any of various other design parameters as will be recognized by those of ordinary skill in the art.

In view of the various performance characteristics of different electric machines, it would be desirable to provide an electric machine that is adaptable and capable of meeting a particular unique performance characteristic, or capable of being differently configured to meet different performance characteristics. It would also be advantageous if such electric machine could be quickly and easily manufactured and available for use in different applications.

While it would be desirable to provide an electric machine that provides one or more of the foregoing or other advantageous features, as may be apparent to those reviewing this disclosure, the teachings disclosed herein extend to those embodiments which fall within the scope of the appended claims, regardless of whether they accomplish one or more of the above-mentioned advantages.

### SUMMARY

In at least one embodiment, a stator for an electric machine includes a winding arranged on a stator core with slots formed in the stator core. The winding includes a plurality of conductors arranged in layers in each of the slots, the layers including an inner layer, an outer layer, and intermediate layers between the inner layer and the outer layer. The plurality of conductors of the winding include a first plurality of interconnected conductors and a second plurality of interconnected conductors positioned in the slots and forming a crown at an end of the stator core. The first plurality of conductors are arranged in the inner layer, the intermediate layers, and the outer layer, and turn portions of the first plurality of interconnected conductors define a standard crown height beyond the end of the stator core. The second plurality of interconnected conductors extend beyond the standard crown height. The winding further includes a plurality of neutral leads extending beyond the crown height and a plurality of phase leads extending beyond the crown height.

In another embodiment, a stator for an electric machine includes a stator core with slots formed in the stator core and a multi-phase winding arranged on the stator core. The multi-phase winding includes a plurality of conductors arranged in layers in each of the slots, the layers including an inner layer, an outer layer, and intermediate layers between the inner layer and the outer layer. Each phase of the multi-phase winding includes at least six parallel paths per phase, and each parallel path extends between a phase lead and a neutral lead.

In yet another embodiment, a method of making a plurality of stators is disclosed herein. The method includes forming a plurality of partial windings on a plurality of stator cores, each stator core having a plurality of slots, each partial winding including a plurality of conductors arranged in the slots. The plurality of conductors form a crown at one end of the stator core and include (i) a first plurality of conductors positioned in the slots and defining a standard crown height, and (ii) a second plurality of conductors extending beyond the standard crown height at the one end of the stator core, the second plurality of conductors including open ends. The method further includes completing a first winding of the plurality of partial windings on a first stator core by making first connections between the open ends of the second plurality of conductors such that the first winding is a multi-phase winding with a first number of parallel paths per phase. Additionally, the method includes completing a second winding of the plurality of partial windings on a second stator core by making second connections between the open ends of the second plurality of such that the second winding is a multi-phase winding with a second number of parallel paths per phase, the second number different than the first number.

### BRIEF DESCRIPTION OF THE DRAWINGS

FIG. 1 shows a schematic arrangement of one phase of a winding arrangement having conductors with extended legs, the extended legs being connected together in order to provide a winding with four parallel paths per phase.

FIG. 2 shows a plan diagram of the connections between the leg ends in the winding arrangement of FIG. 1.

FIG. 3 shows isolated radial side views of the connections between the extended legs in the winding arrangement of FIG. 1, including a first isolated view of the welds between two legs in layer #2 and two legs in layer #3, a second isolated view of the welds between two legs in layer #4 and two legs in layer #5, and a third isolated view of the bus bar connections between two sets of four legs in layer #6.

FIG. 4 shows the winding arrangement of FIG. 1 without the extended legs, the legs of the conductors still connected together in order to provide a winding with four parallel paths per phase.

FIG. 5 shows a schematic arrangement of one phase of a winding arrangement having conductors with extended legs like those of FIG. 1, but the extended legs in FIG. 5 are connected together in order to provide a winding with six parallel paths per phase.

FIG. 6 shows a plan diagram of the connections between the conductor legs in the winding arrangement of FIG. 5.

FIG. 7 shows a plan diagram of the connections of between the conductor legs in the winding arrangement of FIG. 6 for all three phases of the winding arrangement.

FIG. 8 shows a radial side view of all of the connections between the extended legs in the winding arrangement of FIG. 5.

FIG. 9 shows isolated radial side views of the connections between the extended legs in the winding arrangement of FIG. 5, including a first isolated view of the bus bar connections between two legs in layer #2 and two legs in layer #6, a second isolated view of the bus bar connections between two legs in layer #4 and two legs in layer #6, and a third isolated view of two weld connections between two legs in layer #5 and two legs in layer #6.

FIG. 10 shows a view of a neutral bar for the winding arrangement of FIG. 5, wherein the blue leads are neutral leads that are welded to the red neutral bar such that all six paths of each phase is connected to the neutral bus bar.

FIG. 11A is a flowchart of a method 100 of making multiple winding arrangements on multiple stator cores.

FIG. 11B shows a series of isolated side views of the legs of FIG. 5, illustrating a method of making a winding arrangement by twisting leg ends, welding some of the leg ends, and connecting other leg ends with bus bar connections.

FIG. 12A shows a radial side view of the end turns for the winding arrangement of FIG. 5, including a first set of end turns provided on an insertion end of the stator core.

FIG. 12B shows a radial side view of the end turns for the winding arrangement of FIG. 5, including a second set of end turns provided on a weld end of the stator core.

FIG. 13 shows a perspective view of a stator having a winding arrangement similar to that of FIG. 5 positioned thereon, the winding arrangement including conductors with extended legs and connections between the conductors.

FIG. 14 shows a perspective view of the winding arrangement of FIG. 13 with the extended legs of a single phase the bus bar connections removed in order to better show the positions of the extended legs in the winding arrangement.

FIG. 15 shows a perspective view of the winding arrangement of FIG. 13 with only the extended legs and bus bar connections for a single phase illustrated.

FIG. 16 shows the winding arrangement of FIG. 15 with the bus bar connections removed in order to better show the positions of the various extended legs of the illustrated phase.

### DESCRIPTION

A stator winding arrangement is disclosed herein configured for connection with multiple parallel paths per phase, each parallel path extending between a phase lead and a neutral lead. The winding arrangement has a configuration with a limited number of conductors having extended leg ends. The connections made between the extended leg ends allow the winding arrangement to be easily formed as a winding arrangement having four parallel paths or a winding arrangement having six parallel paths. In this manner, stators may be manufactured having different winding arrangements with a different number of parallel paths per phase for each winding arrangement. The performance of the electric machine will have different characteristics depending on the selected number of parallel paths (i.e., four or six). In some cases, fewer parallel paths (i.e., four) will be desired, and in some cases a greater number of parallel paths (e.g., six) will be desired, depending on the intended application for the electric machine.

Winding Arrangement with Four Parallel Paths Per Phase

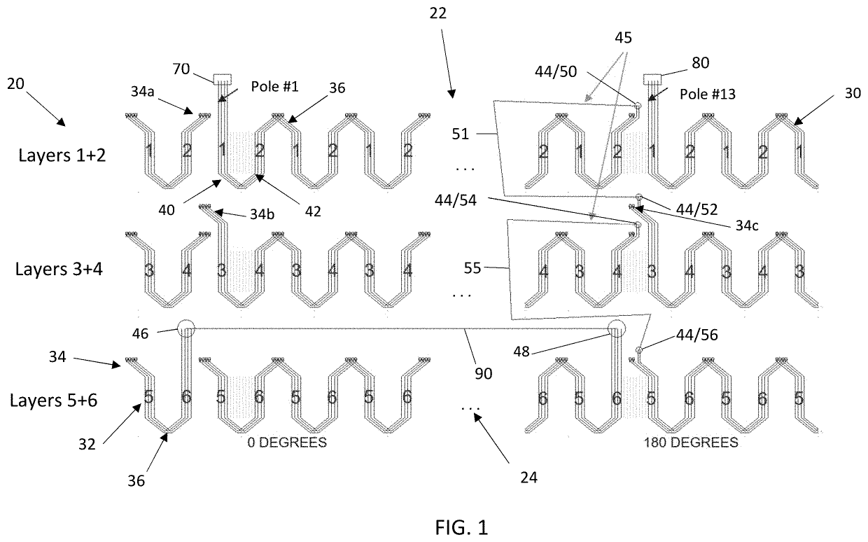

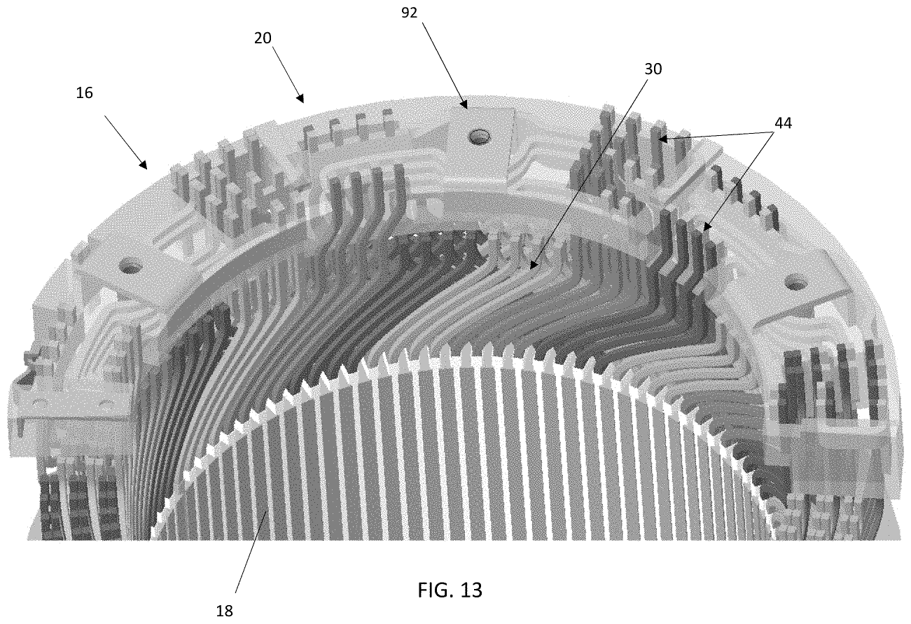

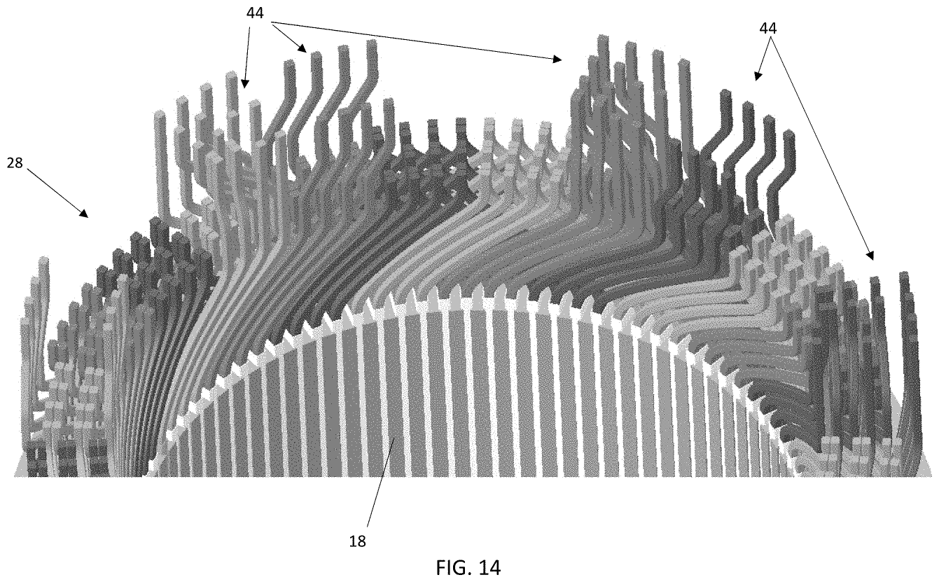

With reference now to FIG. 1, a schematic arrangement of one phase of a winding arrangement 20 is shown. The winding arrangement 20 (which may also be referred to herein as simply a “winding”) includes conductors that are interconnected to form multiple parallel paths per phase. The winding 20 is configured for a stator having eight poles, four slots per pole per phase, and six conductors per slot (i.e., six layers of conductors in each slot of the stator core, as noted by layer #s 1-6 in FIG. 1). The conductors may be provided as either segmented conductors (which may also be referred to as “hairpins” or “U-shaped conductors”), or alternatively, a continuous wound bar winding. As will be recognized by those of ordinary skill in the art, the conductors 30 include in-slot portions 32 that extend through the slots 18 of the stator core 16 (not shown in FIG. 1; see FIG. 13), end turns 36 arranged on an insertion end of the stator core, leg ends 34 that extend from a weld end of the stator core, phase leads 70 and neutral leads 80. Each end turn 36 extends between two in-slot portions 32, and each leg end 34 is connected to another leg end (e.g., via a weld or a bus bar). An example of a stator with segmented conductors that are interconnected to form a winding is shown in US Patent Publication No. 2021/0159743, the contents of which are incorporated herein by reference.

With continued reference now to the exemplary embodiment of FIG. 1, the winding 20 is a multi-phase winding arrangement (e.g., a three-phase winding) comprised of segmented conductors that are connected together to form four parallel paths per phase, each parallel path extending between a phase lead 70 and a neutral lead 80. Only one phase of the winding is shown in FIG. 1, with conductors shown in each of the six layers. A break 22 is shown in the center of the figure between the left side conductors and the right side conductors, but as noted by the ellipsis 24, the break 22 is merely shown for convenience of illustration, and the same conductor pattern continues until the left side conductors are connected to the right side conductors (note that Pole #1 is shown on the left at 0 degrees, and Pole #13 is shown on the right at 180 degrees).

As shown in FIG. 1, the conductors 30 are arranged in slot sets such that four in-slot portions 32 from consecutive conductors extend through four consecutive slots of the stator core (stators of this type are commonly referred to as having four “slots-per-pole-per-phase”). For a given set of four hairpin conductors of one phase, first in-slot portions extend through slots 1-4 (i.e., pole #1), second in-slot portions extend through slots 13-16 (i.e., pole #2), and end turns that connect each of the in-slot portions. The end turns (which may also be referred to herein as “turn portions”) in the winding are formed by U-turns in the hairpins arranged on the insertion side of the stator core or by connections (e.g., welds) between conductor leg ends on the weld side of the stator core.

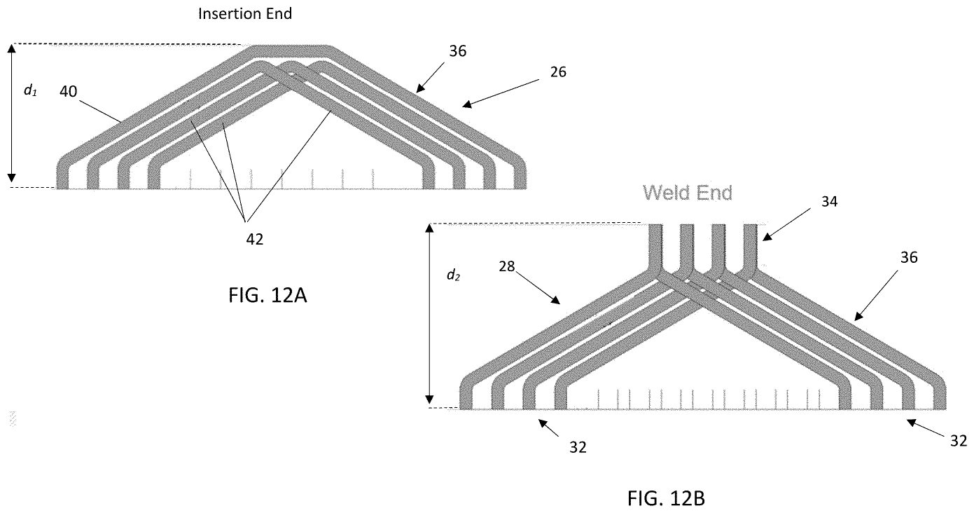

On the insertion end of the stator core, the end turns 36 are both interleaved and nested, with the inner conductors on the insertion end interleaved and nested within an outer turn portion that extends between two poles. Accordingly, for the conductors associated with pole #1 and pole #2 in FIG. 1, the inner end turns 42 are interleaved between slots 2-4 and 13-15; the outer end turn 40 extends axially beyond the inner end turns 42 and extends radially between slots 1 and 16 of the stator core such that the inner end turns 42 are nested within the outer end turn 40 on the insertion end of the stator core. This nested and interleaved arrangement is also illustrated in greater detail in FIG. 12A.

On the opposite end of the stator core (i.e., the weld end), the conductors are interleaved with the exception of the unique connections provided by the extended leg ends 44, as described in further detail below. Accordingly, for the conductors associated with pole #2 and pole #3, the end turns 36 on the weld end of the stator extend between slots 13-16 and associated slots 25-29 and are interleaved such that they cross each other on the weld end of the stator core (with the end turn from slot 13 extending to slot 25, the end turn from slot 14 extending to slot 15, etc.). This interleaved arrangement is also illustrated in greater detail in FIG. 12B.

A comparison of FIGS. 12A and 12B illustrates the difference between the end turns on the insertion end and the weld end of the stator core. On the insertion end of the stator core (FIG. 12A), the outer end turn 40 for each set of end turns 36 extends over/bridges all of the inner end turns 42. As a result, the outer end turn 40 has a greater pitch than the inner end turns 42, with each of the inner end turns 42 having the same pitch. On the weld end of the stator core (FIG. 12B), each of the leg ends 34 are connected together and define a standard pitch between connected in-slot portions 32.

The end turns 36 form two crowns 26, 28 on opposite sides of the stator core. As shown in FIG. 12A, all of the outer end turns 40 extend an axial distance d1 beyond the insertion end of the stator core, and define a first crown height d₁ on the insertion end of the stator core. As shown in FIG. 12B, and as explained in further detail below, most (but not all) of the leg ends 34 are standard length legs that extend the same axial distance beyond the stator core and define a second crown height d₂ on the weld end of the stator core. This second crown height d₂ may also be referred to herein as a “standard crown height.” As explained below, other leg ends 34 are longer than most of the leg ends 34 on the weld end, and provide extended leg ends on the weld end of the stator core.

With reference now to FIGS. 1-3, for each phase of the winding arrangement, most of the conductors 30 have standard length leg ends 34. However, some of the conductors have extended leg ends 44 that extend significantly beyond/past the standard leg ends (e.g., 10%-50% further beyond the standard legs in the axial direction). The extended leg ends 44 may also be referred to herein as “elongated,” “long” or “tall” legs. In the embodiment of FIGS. 1-3, the extended legs include each of the following groups of leg ends: (1) the phase leads 70 and neutral leads 80 in layer #1 of the winding (i.e., the outer layer or alternatively vice-versa, wherein layer #1 is the inner layer and layer 36 is the outer layer in some embodiments), (2) two conductors (per phase) in each of the intermediate layers (i.e., layer #2, layer #3, layer #4, and layer #5), and (3) two groups of four adjacent conductors (i.e., 8 total leg ends) in the inner layer of the winding (i.e., layer #6, or alternatively vice-versa, wherein layer #6 is the outer layer and layer #1 is the inner layer in some embodiments).

In FIG. 1, the extended leg ends 44 in the inner layer are designated by the rectangles 70 and 80. The extended leg ends in the outer layer are designated by the circles 46 and 48. The extended legs in the intermediate layers are designated by the four circles 50, 52, 54 and 56 around the conductor ends shown on the right side of the winding arrangement 20.

Several connections are provided between the extended legs associated with circles 46, 48, 50, 52, 54, and 56. The leads associated with circles 46 and 48 are electrically connected as noted by connection 90. As noted by connection 51, the two extended leg ends 44 in layer #2 (see circle 50) are electrically connected (e.g., welded) to the two extended leg ends 44 in layer #3 (see circle 52). Accordingly, the winding arrangement transitions from layer #s 1 and 2 to layer #s 3 and 4 (and vice-versa) at this connection indicated by line 51. Similarly, the two extended leg ends 44 in layer #4 (see circle 54) are electrically connected (e.g., welded) to the two extended leg ends 44 in layer #5 (see circle 56). Accordingly, the winding arrangement transitions from layer #s 3 and 4 to layer #s 5 and 6 (and vice-versa) at this connection indicated by connection 55. It will be recognized that the lines showing connections 51, 55 and 90 in FIG. 1 are singular for the sake of convenience only, and that these connections 51, 55 and 90 are actually provided by multiple connections, each of which individually connects two adjacent leads. In particular, as described in further detail below, two tall welds 45 provide the connection 51, two additional tall welds 45 provide the connection 55, and a bus bar provides the connection 90.

Again, only the leg ends associated with circles 48, 50, 52, 54 and 56, and rectangles 70 and 80 (i.e., the phase leads and neutral leads) are extended leg ends 44. All other leg ends 34 of the winding 20 are standard length leg ends. While several additional leg ends may appear to be extended leg ends in FIG. 1, these leg ends are extended merely for the sake of convenience of illustration. For example, the leg ends 34b of layer #3 are standard leg ends that are welded to the leg ends 34a of layer #2. Similarly, the leg ends 34c positioned in layer #3 of the slots next to the extended leg ends associated with circle 52 are only standard leg ends, but are extended in FIG. 1 for convenience of illustration. These standard length leg ends 34c are connected to the standard length leg ends of layer #2 which are shown next to the extended leg ends associated with circle 50. Similarly, the standard length leg ends shown next to the extended leg ends of layer #4 (associated with circle 54) are connected to the standard length leg ends shown next to the extended leg ends of layer #5 (associated with circle 56).

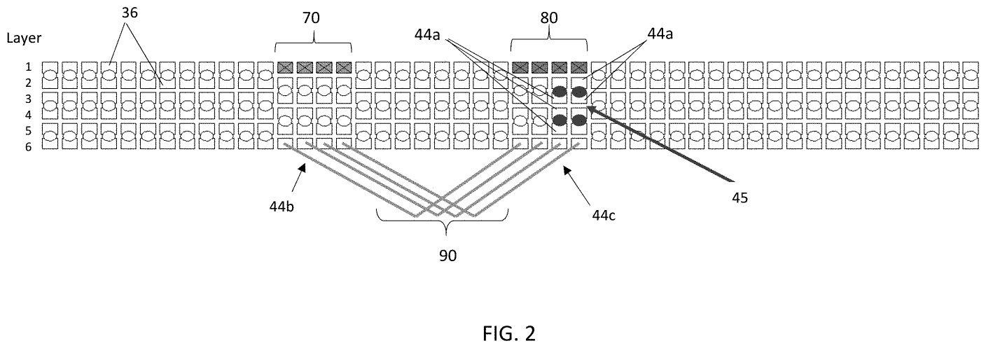

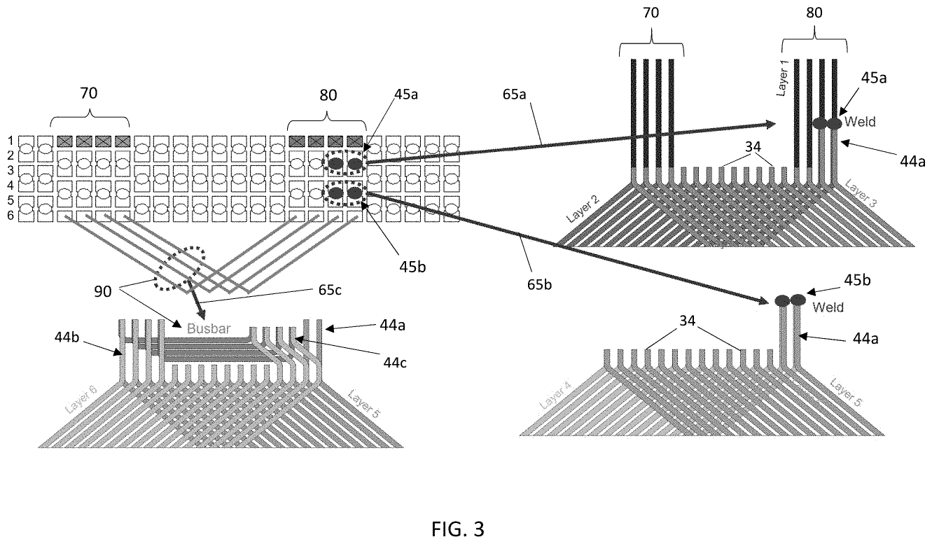

With reference now to FIGS. 2 and 3, diagrams of the connections between the leg ends 34 in the exemplary winding arrangement of FIG. 1 are shown. As illustrated in FIGS. 2 and 3, because the winding includes four parallel paths (per phase) four phase leads 70 are shown (one for each parallel path of the illustrated phase), and four neutral leads 80 are shown (one for each parallel path of the illustrated phase).

FIG. 2 is a top/plan view illustrating the weld end of the winding arrangement wherein the squares represent the leg ends 34 after twisting. The ovals between the squares represent a weld between two adjacent legs. The non-darkened ovals represent welds between standard length leg ends. The darkened ovals indicate welds between extended leg ends 44. As can be seen in FIG. 2, all of the phase leads 70 are arranged in an outermost layer of the winding (i.e. layer #1) and noted by darkened rectangles (with an “x” inside the rectangle). Similarly, all of the neutral leads 80 are also arranged in the outermost layer and are also noted by darkened rectangles with an “x” inside the rectangle. Four tall welds 45 (i.e., welds connecting extended leg ends 44 as noted by the darkened ovals in FIG. 2) are also shown in FIG. 2. These four tall welds 45 connect eight different extended leg ends 44a that are all grouped together in in the intermediate layers of the winding (i.e., in layer #s 2-5). In particular, two of the tall welds 45 connect two extended leg ends 44 in layer #2 to two adjacent extended leg ends 44 in layer #3. Similarly, two additional tall welds 45 connect two extended leg ends 44 in layer #4 to two adjacent extended leg ends 44 in layer #5. While the welds 45 are referred to herein as “tall welds” it will be noted that this terminology is used because they weld extended leg ends, and not because the welds themselves are necessarily tall or different from any other welds in the winding.

With continued reference to FIG. 2, four bus bar series connections 90 are also shown connecting a first set 44b of four extended leg ends 34 in the inner layer of the winding (i.e., layer #6) to a second set 44c of four extended leg ends in the inner layer. These series connections 90 may be provided by segmented conductors that extend between remote (i.e., non-adjacent) extended leg ends 44. For example, one conductor joins the leftmost leg end in set 44b to the leftmost leg end in set 44c. Standard welds may also be used to connect the series connections to the associated leg ends in each of extended leg end sets 44b and 44c.

FIG. 3 shows isolated radial side views of the connections between the extended leg ends 44a, 44b and 44c of FIG. 2. The top left diagram of FIG. 3 is a condensed version of the plan view of FIG. 2, and arrows 65a, 65b, 65c point to isolated radial side views of the respective connections between the extended leg ends 44 that are shown in the top left plan view. In particular, arrow 65a of FIG. 3 points to an isolated radial side view of the tall welds 45a that connect the extended leg ends 44a of layer #2 to the extended leg ends 44a of layer #3. The tall leg ends of layer #1 associated with the phase leads 70 and the neutral connections 80 are also visible in this view. Arrow 65b of FIG. 3 points to an isolated radial side view of the tall welds that connect the extended leg ends 44a of layer #4 to the extended leg ends 44a of layer #5. Arrow 65c of FIG. 3 points to an isolated radial side view of the bus bar connections that connect the first set 44b of extended leg ends of layer #6 to the second set 44c of extended leg ends of layer #6.

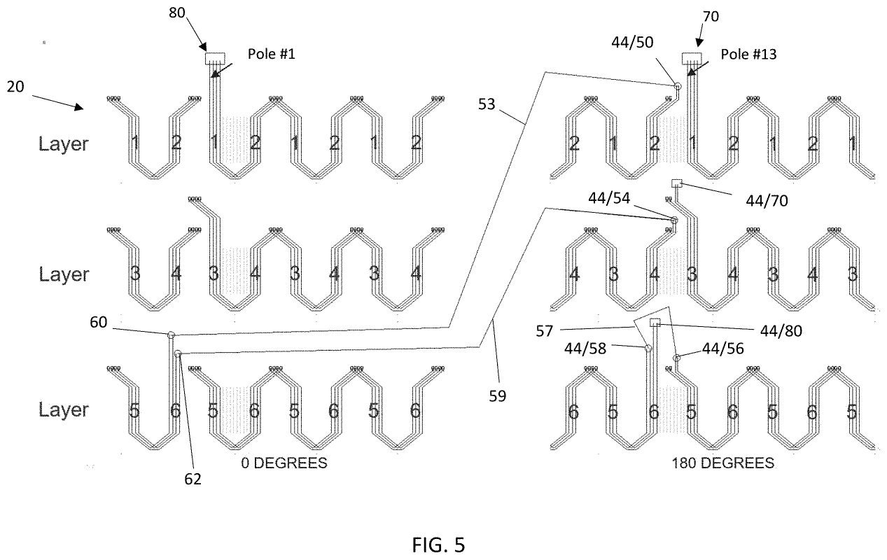

Advantageously, each of the leg ends associated with the tall welds 45, phase leads 70, neutral leads 80, and bus bar connections 90 are provided by extended leg ends 44 that may be quickly and easily identified. As explained in further detail below, these extended leg ends 44 facilitate a method of stator manufacturing that allows stators to be quickly and easily configured with windings having four parallel paths (as shown in FIGS. 1-3) or alternatively, windings having six parallel paths (as shown in association with FIGS. 5-10). The tall welds 45 and bus bar connections 90 are all arranged beyond the standard end crown height. As such, identification of the associated connection locations is easily recognized and accessed by the manufacturer.

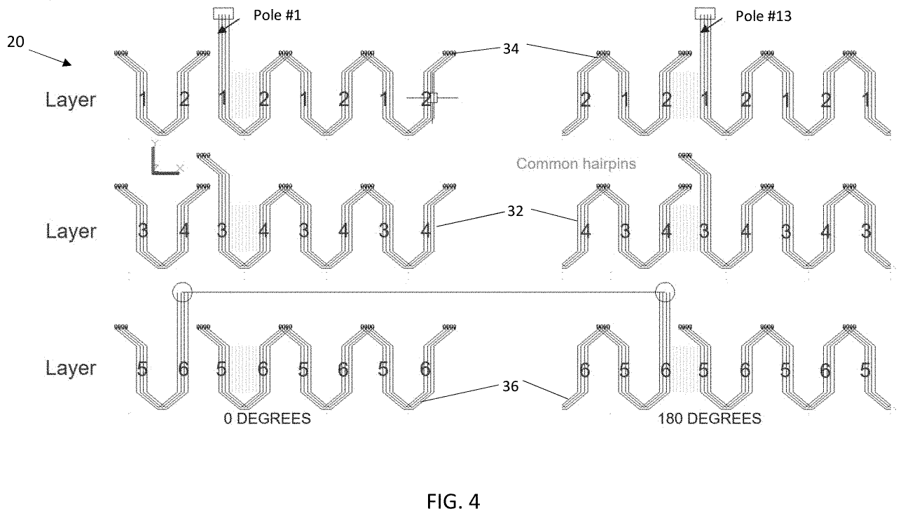

While the winding arrangement 20 is shown in FIGS. 1-3 as having extended leg ends 44, it will be recognized that, in at least one embodiment, a comparable winding arrangement may also be formed without the use of extended leg ends 44. For example, as shown in FIG. 4, the same winding arrangement of FIG. 1 is shown, but standard hairpins are substituted for the extended leg ends 44 of FIG. 1. In the embodiment of FIG. 4, the legs of the conductors are connected together in the same manner as those of FIG. 1 in order to provide a winding with four parallel paths per phase. However, the special connections required to form the winding are not as apparent in FIG. 2 because there are no extended leg ends. Moreover, in embodiments without extended leg ends 44 (such as that of FIG. 3), the connections required to complete the winding as either a four parallel path winding (as shown in FIGS. 1-3) or a six parallel path winding (as shown in FIGS. 5-10 and explained in further detail below) are not as apparent.

The winding of FIGS. 1-3 is but one of many possible embodiments of a winding arrangement that may be used with or without extended leg ends. In other embodiments, the winding may have a different features and performance characteristics. For example, while the winding arrangement of FIGS. 1-3 provides a stator with four slots-per-pole-per-phase, stators having a different number of slots-per-pole-per-phase may also be provided. Such a stator with a different number of slots-per-pole-per-phase would have a similar design to that of FIGS. 1-3, except the number of parallel wires would be different. Accordingly, a stator having 2 slots per pole per phase could have either a two parallel path design or a three parallel path design created by similar connection patterns as shown and described herein. In this embodiment, the figures would be similar to those of FIGS. 1-3, except only two in-slot portions 32 from consecutive conductors extend through two consecutive slots of the stator core. Also the phase leads 70, neutral leads 80, the elongated leg ends 44 noted at circles 50, 52, 54, 56 would only be associated with half the number of wires as that shown in FIG. 1. For example, phase leads 70 would have only two wires instead of the four wires shown in FIG. 1. Accordingly, it will be appreciated that the specific winding arrangement of FIGS. 1-3 is but one exemplary embodiment of the disclosed stator and winding arrangement having multiple parallel paths, and numerous other embodiments are possible, including the following winding arrangement with six parallel paths per phase.

Winding Arrangement with Six Parallel Paths Per Phase

With reference now to FIGS. 5-10, in at least one embodiment, the stator winding 20 may be configured with connections that result in six parallel paths (per phase). All of the conductors in the winding arrangement are arranged the same as that of FIGS. 1-3, but the extended leg ends 44 are connected differently in order to provide six parallel paths (per phase) for the winding 20, instead of four.

As shown in FIG. 5, in order to provide the six parallel paths (per phase) in the winding 20, the two extended leg ends 44 of layer #2, as noted at circle 50, are connected by a bus bar connection 53 to two of the extended legs of layer #6, as noted at circle 60. As will be recognized, because these extended leg ends are non-adjacent remote leg ends, the extended leg ends cannot be welded together, and two elongated conductors are used for the bus bar connection 53. Similarly, the two extended leg ends 44 of layer #4, as noted at circle 54 in FIG. 5, are also connected by a bus bar connection 59 to two of the extended leg ends of layer #6, as noted at circle 62 in FIG. 5. Additionally, the two extended leg ends 44 of layer #5, noted at circle 56 in FIG. 5, are also connected by a bus bar connection 57 to two extended legs of layer #6, noted at circle 58 in FIG. 5. Alternatively, because the extended leg ends associated with circles 56 and 57 are so close in layer #5 and layer #6, it is possible to bend the leg ends so they are adjacent and a weld connection may be made between these leg ends.

Because the winding of FIG. 5 includes six parallel paths (per phase), six phase connection are provided and six neutral connections are also provided (per phase). The six phase leads 70 include four phase leads in layer #1 and two phase leads in layer #3. The six neutral leads 80 include four neutral leads in layer #1 and four neutral leads in layer #6, as shown in FIG. 5.

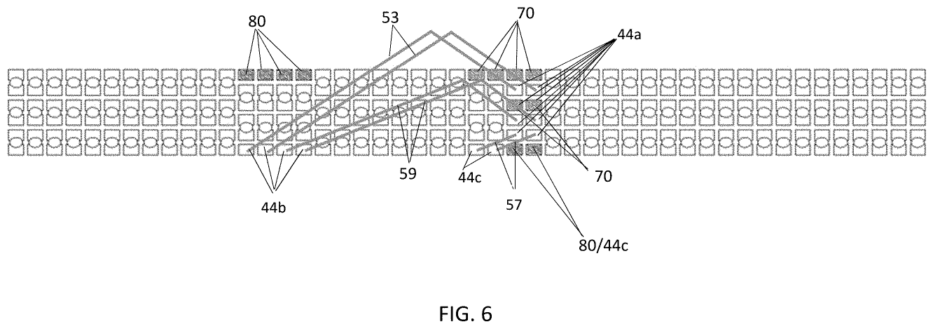

Additional disclosure concerning the connections between the extended leg ends in the winding of FIG. 5 are shown in further detail in FIGS. 6-10. FIG. 6 shows a plan diagram of the connections between the conductor legs in one phase of the winding arrangement of FIG. 5, including each of the connections 53, 57 and 59. This plan diagram is similar to that of FIG. 2, but again the different connections between the extended leg ends 44, including connections 53, 57 and 59, results in a six parallel path per phase arrangement, instead of four.

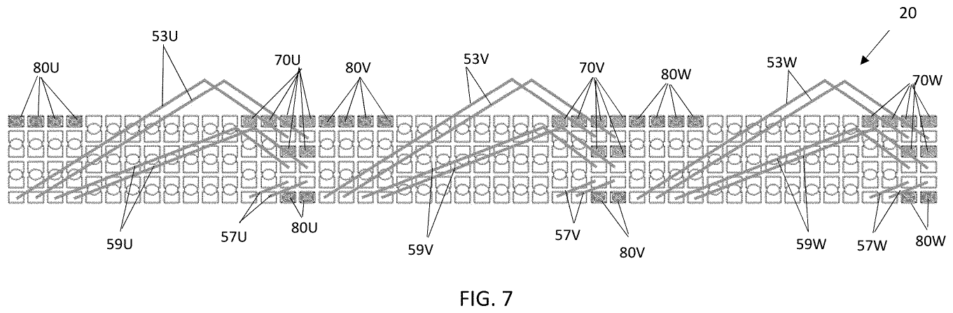

FIG. 7 shows a plan diagram similar to that of FIG. 6, but showing connections for all three phases of the winding 20. These include connections for each of phase U, phase V, and phase W of the electric machine. Accordingly, the phase leads include leads 70U, 70V, and 70W. The neutral leads include leads 80U, 80V and 80W. The connections between extended leg ends include bus bar connections 53U, 53V, 53W, 59U, 59V and 59W, as well as tall welds/connections 57U, 57V, and 57W. As can be seen in FIG. 7, the three phases are spread out and cross a few poles so that none of the tall end loops or bus bar connections interfere with each other.

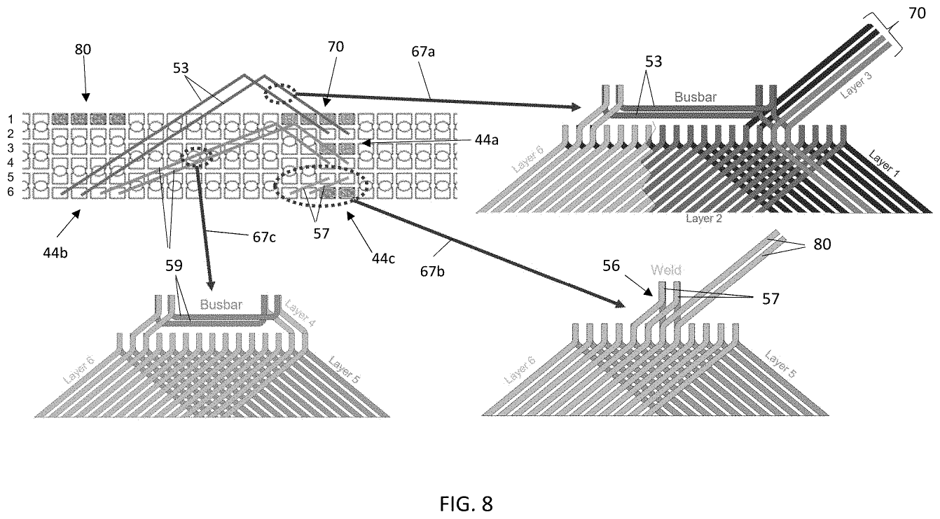

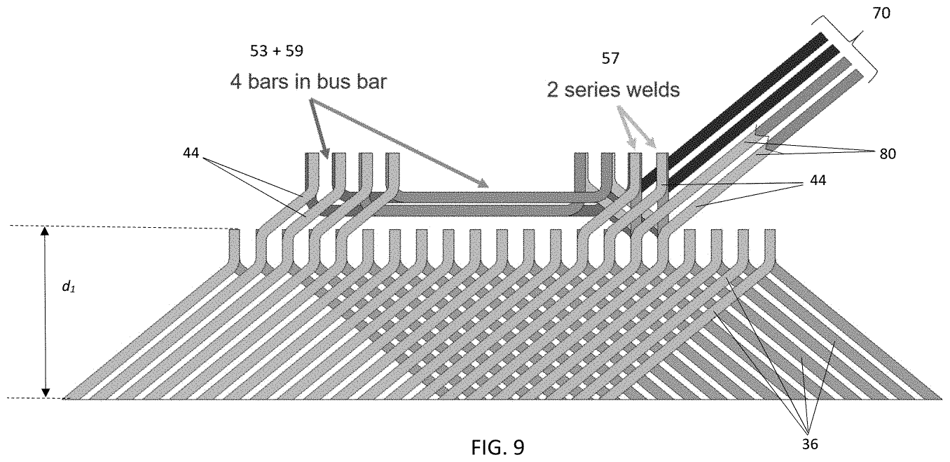

FIGS. 8-9 show radial side views of the connections between the extended legs in the winding arrangement of FIG. 5, including connections 53, 57 and 59. FIG. 8 is similar to FIG. 3, and shows isolated radial side views of the connections between the all of the extended leg ends 44a, 44b and 44c of FIG. 6. The top left diagram of FIG. 8 is a condensed version of the plan view of FIG. 6, and arrows 67a, 67b, 65c point to isolated radial side views of the respective connections between the extended leg ends 44 that are shown in the top left plan view.

Arrow 67a of FIG. 8 points to an isolated radial side view of the bus bar connections 53 that connect the extended leg ends of layer #2 (that are part of group 44a) to the extended leg ends of layer #6 (that are part of group 44c). The tall leg ends of layer #s 1 and 3 associated with the phase leads 70 are also visible in this view.

Arrow 67b of FIG. 8 points to an isolated radial side view of the tall welds 57 that connect the extended leg ends of layer #5 (that are part of group 44a) to the extended leg ends of layer #67c (that are part of group 44a). The tall leg ends of layer #6 that are associated with the neutral leads 80 (and are part of group 44c) are also visible in this view.

Arrow 67c of FIG. 8 points to an isolated radial side view of the bus bar connections 59 that connect the extended leg ends of layer #4 (that are part of group 44c) to the extended leg ends of layer #6 (that are part of group 44b).

FIG. 9 is a radial side view of the extended legs of the winding 20 of FIG. 5 (excluding the four neutral leads of layer #1). This view is a combination of each of the views illustrated by arrows 67a, 67b, and 67c of FIG. 8. As can be seen in FIG. 9, the standard leg ends 34 extend a standard crown height d₁ beyond the end of the stator core. However, the extended leg ends 44 extend past the standard crown height and are either connected together with bus bars 53, 59 or tall welds 57, or are alternatively used to provide phase leads 70 and neutral leads 80. It will be recognized that FIG. 9 only shows a portion of the neutral leads 80 of layer #6, and the ends of the leads are cut away to expose the two phase leads in layer #3 of the same slots.

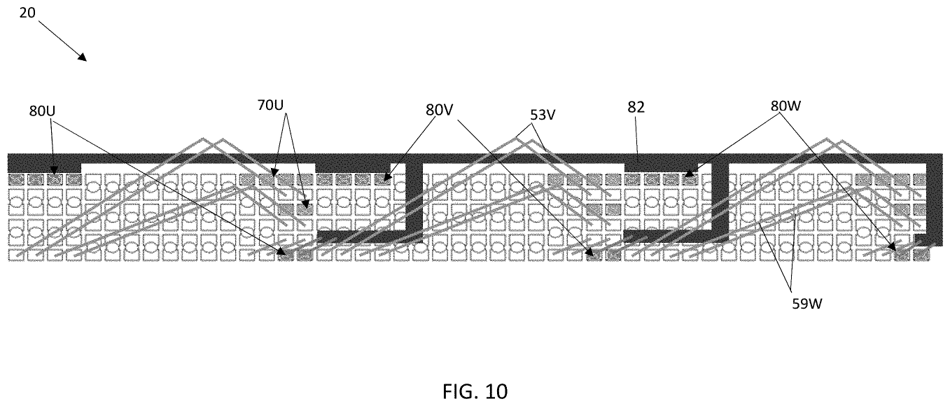

FIG. 10 shows a plan view of the winding, similar to FIG. 7, but also including a neutral bar 82 for the winding arrangement of FIG. 5. In FIG. 10, the neutral leads 80U, 80V and 80W are welded to the darkened neutral bar 82. FIG. 10 shows the neutral leads 80U, 80V and 80W for all six paths of each phase of a three-phase winding arrangement. The neutral bar 82 connects four leads in layer #1 for each phase, and two leads in layer #6 for each phase. Thus, the neutral bar 82 includes a portion that extends around the leads of layer #1 (i.e., around the outer layer) as well as three reverse L-shaped portions that extend over the welded connections of the winding arrangement 20 and allow the two leads for each phase in layer #6 to be connected to the neutral bar 82 (and thus the associated four leads for each phase in layer #1).

The foregoing embodiments, and particularly the embodiment of FIGS. 5-10, discloses a novel winding arrangement including six parallel paths per phase in a three-phase winding arrangement. The foregoing embodiments shown in FIGS. 1-10 also disclose a stator family including a limited number of long legs that may be differently connected in order to form different winding configurations. In the embodiment of FIGS. 1-3, the welds and bus bars connect the long legs and provide a four parallel path (per phase) winding arrangement. In FIGS. 5-10, different welds and bus bars are used to connect the long legs and provide a six parallel path (per phase) winding arrangement.

Method of Making Multiple Winding Arrangements on Multiple Stator Cores

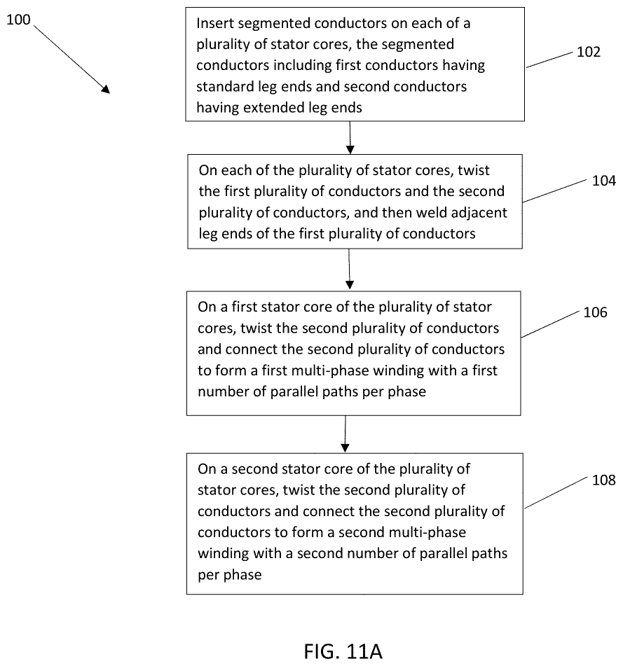

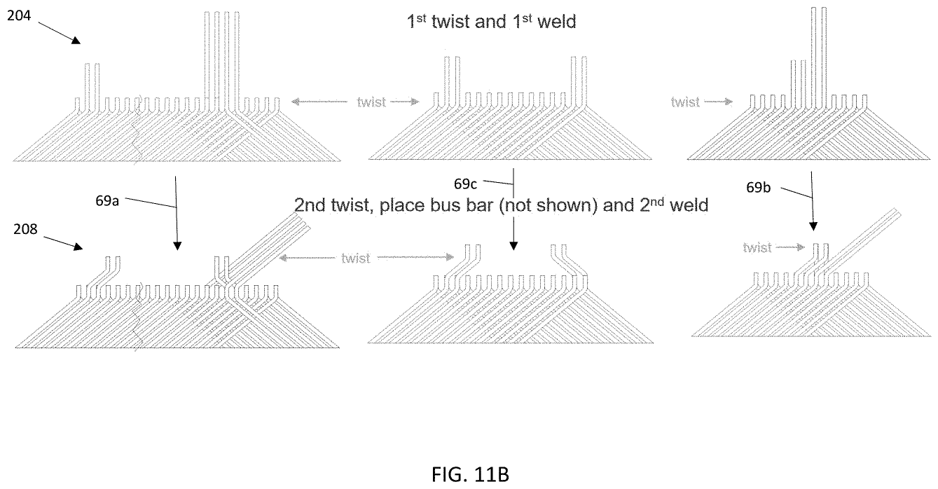

With reference now to FIG. 11A, a method 100 of making multiple winding arrangements on multiple stator cores is disclosed. The method 100 begins at block 102, when segmented conductors are inserted on each of a plurality of stator cores. The segmented conductors include first conductors having standard leg ends and second conductors having extended leg ends. Examples of stators with winding arrangements having both standard leg ends and extended leg ends are described above in association with FIGS. 1-3 and 5-10.

After the conductors are inserted into the stator cores, the method 100 continues at block 104. At block 104 the first plurality of conductors and the second plurality of conductors are twisted on each of the plurality of stator cores. This twisting is general done in a conventional manner to form adjacent leg ends configured to provide end turns on the weld end of the winding. Adjacent leg ends of the first plurality of conductors (i.e., the conductors having standard leg ends) are then welded together to form a partial winding arrangement on each of the plurality of stator cores. As discussed previously, the adjacent leg ends of the first plurality of conductors define a standard crown height for the winding at the weld end of the stator core. At the completion of block 104, the plurality of stator cores are configured with partially completed windings. The plurality of stator cores includes at least a first stator core and a second stator core.

After the first plurality of conductors are welded together and partially completed windings are formed on the plurality of stator cores, the method continues at block 106. At block 106, the partial winding on the first stator core is manipulated to form a completed first winding arrangement having a first number of parallel paths per phase. In particular, the second plurality of conductors (i.e., the conductors having extended leg ends) are further twisted to locations that will facilitate completion of the first winding arrangement. After twisting the second plurality of conductors on the first stator core, connections are made between the leg ends of the second plurality of conductors (e.g., bus bar connections or welds, as appropriate) in order to complete the first winding on the first stator core. Again, this first winding is a multi-phase winding having a first number of parallel paths per phase.

After the first winding is formed on the first stator in block 106, the method 100 continues to block 108 and a second winding is completed on a second stator core. At block 108, the partial winding on the second stator core is manipulated to form a completed second winding arrangement having a first number of parallel paths per phase. In particular, the second plurality of conductors on the second stator core are further twisted to locations that will facilitate completion of the second winding arrangement, wherein the second winding arrangement is different from the first winding arrangement. After twisting the second plurality of conductors on the second stator core, connections are made between the leg ends of the second plurality of conductors (e.g., bus bar connections or welds, as appropriate) in order to complete the second winding on the first stator core. This second winding is a multi-phase winding having a second number of parallel paths per phase, the second number being different than the first number (i.e., the second winding arrangement has a different number of parallel paths per phase than the first winding arrangement).

FIG. 11B shows a series of isolated radial side view of different portions of one of the stators during the method 100 of assembling stators as shown and described above in association with FIG. 11A. The three views 204 of the winding in the top row of FIG. 11B show the conductors at the completion of block 104 wherein the first and second plurality of conductors are twisted and adjacent standard leg ends are welded together. The three views 208 of the winding in the bottom row of FIG. 11B show the conductors at the completion of block 108 wherein the second plurality of conductors are further twisted prior to making connections between the extended leg ends. Arrow 69a illustrates the transition of a first group of conductors between blocks 104 and 108 of the method. Arrow 69a points to a view of the conductors that corresponds to the view associated with arrow 67a of FIG. 8. Similarly, arrow 69b points to a view of the conductors that corresponds to the view associated with arrow 67b of FIG. 8. Also, arrow 69c points to a view of the conductors that corresponds to the view associated with arrow 69c of FIG. 8.

It will be recognized that FIG. 11B illustrates a method of making a winding arrangement by, in sequence: 1) twisting leg ends, 2) welding some of the leg ends, 3) twisting long leads and 4) connecting leg ends with bus bar connections. The top series of drawings in FIG. 11B illustrates the first twist of the hairpin legs (as in conventional segmented winding formation) every other layer is twisted every other direction and then the legs are welded together. The bottom series of views in FIG. 11B shows the second twist to of the long legs above the normal hairpin weld. The bus bar (not shown in FIG. 11B) is then placed on the winding and the copper tracks of the bus bar are welded to the long legs that have been second twisted. In the bottom right view in FIG. 11B (i.e., the view associated with arrow 69b), the two long secondary twisted wires/leg ends are welded to two long wires/leg ends from a different layer that were not secondary twisted. As shown in the bottom left view in FIG. 11B (i.e., the view associated with arrow 69a), some of the leads/leg ends are twisted in one direction to as a normal hairpin twist (i.e., the top figure associated with arrow 69a) and then twisted in the opposite direction above the normal hairpin weld (i.e., the bottom view associated with arrow 69a). As shown in middle bottom view of FIG. 11B (i.e., the view associated with arrow 69c), still other leads/leg ends twist in one direction for the normal hairpin twist and then further twist in the same direction above the normal hairpin twist.

As discussed previously, FIG. 12 shows a radial side view of the end turns for the winding arrangement of FIGS. 1 and 5, including a first set of end turns provided on an insertion end of the stator core and a second set of end turns provided on a weld end of the stator core. On the insertion end of the stator core, for each set of end turns, the inner end turns 42 are interleaved and nest within the outer end turns 40. Although FIG. 12, as well as other figures, and most of the description herein references hairpins and hairpin welds, it will be recognized that a winding having a continuous bar wound stator would look the same as these figures except the normal hairpin welds would be replaced by a continuous bar.

Stator Core and Winding Arrangement

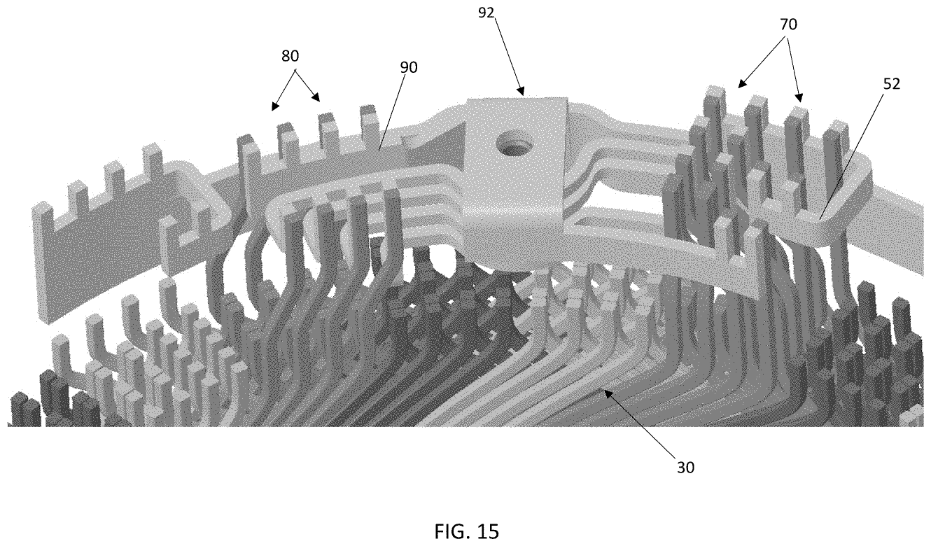

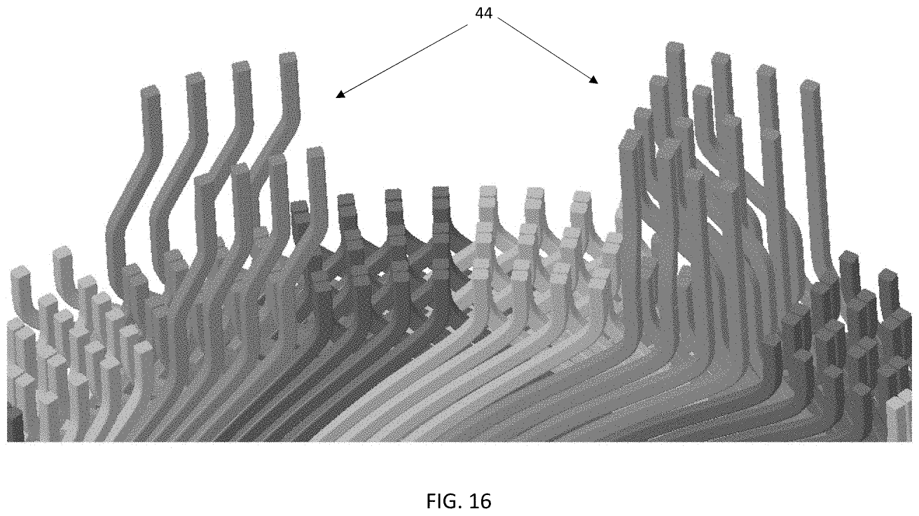

FIGS. 13-16 show perspective views of a stator core 16 with a winding arrangement 20 arranged on the stator core 16, such as the winding arrangement described above in association with FIGS. 5-10. FIG. 13 shows three phases of the winding arrangement positioned on the stator core 16 (each phase illustrated in a different shade), including a bus bar 92 that provides various connections between extended leg ends 44 in the three phases. FIG. 14 shows the winding arrangement of FIG. 13 with the bus bar 92 removed in order to better show the positions of the various conductors and their associated extended leg ends 44. FIG. 15 is similar to FIG. 13, but only shows the conductors 30, extended leg ends 44, and the bus bar 92 connections for a single phase of the winding arrangement. FIG. 16 shows the winding arrangement of FIG. 15 with the bus bar connections removed in order to better show the positions of the various extended leg ends 44 of the illustrated phase.

It will be recognized that numerous additional embodiments of the winding arrangement 20 disclosed herein are possible, by making various modifications to the winding arrangement. For example, the winding arrangement 20 of FIGS. 13-16 is substantially the same as that shown in FIGS. 5-10, but in FIGS. 13-16, the twists in the elongated conductors is different than that of FIGS. 5-10. In particular, as best shown on the right side of FIG. 16, two of the extended leg ends 44 are twisted in layer #5 instead of in layer #6 (as is shown in association with FIGS. 5-10). While the winding arrangement 20 could be formed either way without change in performance, there may be reasons to make modifications such as this for any of various reasons (e.g., in order to allow for more clearance at some position in the winding arrangement).

Although the various embodiments have been provided herein, it will be appreciated by those of skill in the art that other implementations and adaptations are possible. Furthermore, aspects of the various embodiments described herein may be combined or substituted with aspects from other features to arrive at different embodiments from those described herein. Thus, it will be appreciated that several of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by any eventually appended claims.

What is claimed is:

1. A stator for an electric machine comprising:
a stator core with slots formed in the stator core; and
a winding arranged on the stator core, the winding including a plurality of conductors arranged in layers in each of the slots, the layers including an inner layer, an outer layer, and intermediate layers between the inner layer and the outer layer, the plurality of conductors including:
a first plurality of interconnected conductors positioned in the slots and forming a crown at an end of the stator core, the first plurality of conductors arranged in the inner layer, the intermediate layers, and the outer layer, and turn portions of the first plurality of interconnected conductors defining a standard crown height beyond the end of the stator core;
a second plurality of interconnected conductors positioned in the slots and extending beyond the standard crown height;
a plurality of neutral leads extending beyond the standard crown height; and
a plurality of phase leads extending beyond the standard crown height.

2. The stator of claim 1 wherein the second plurality of interconnected conductors are arranged in the intermediate layers, each of the second plurality of conductors defining an extended leg end.

3. The stator of claim 2 wherein the intermediate layers include a first intermediate layer, a second intermediate layer, a third intermediate layer, and a fourth intermediate layer.

4. The stator of claim 2 wherein the second plurality of interconnected conductors include at least two adjacent extended leg ends that are welded together beyond the standard crown height.

5. The stator of claim 4 wherein the winding is a multi-phase winding with four parallel paths per phase.

6. The stator of claim 2 wherein the second plurality of interconnected conductors include at least two remote leg ends connected by a bus bar arranged beyond the standard crown height.

7. The stator of claim 6 wherein the winding is a multi-phase winding with six parallel paths per phase.

8. The stator of claim 1 wherein the plurality of conductors include a plurality of segmented conductors, each of the segmented conductors including a U-turn and two leg ends.

9. A stator for an electric machine comprising:
a stator core with slots formed in the stator core; and
a multi-phase winding arranged on the stator core, the multi-phase winding including a plurality of conductors arranged in layers in each of the slots, the layers including an inner layer, an outer layer, and intermediate layers between the inner layer and the outer layer, each phase of the multi-phase winding including at least six parallel paths per phase, and each parallel path extending between a phase lead and a neutral lead.

10. The stator of claim 9, the plurality of conductors forming a crown and including:
a first plurality of conductors positioned in the slots and defining a standard crown height extending beyond an end of the stator core;
a second plurality of conductors positioned in the slots and extending beyond the standard crown height;
a plurality of neutral leads extending beyond the standard crown height; and
a plurality of phase leads extending beyond the standard crown height.

11. The stator of claim 10 wherein the first plurality of conductors are arranged in the inner layer, the intermediate layers, and the outer layer, and wherein the second plurality of conductors are arranged in the intermediate layers.

12. The stator of claim 10 wherein pairs of the second plurality of conductors are connected together with a bus bar.

13. The stator of claim 10 wherein the layers are arranged as six total layers including one outer layer, four intermediate layers, and one inner layer.

14. The stator of claim 10 wherein the plurality of conductors are hairpin conductors.

15. The stator of claim 14 wherein only a single conductor is positioned in each layer of each slot of the stator core.

16. A method of making a plurality of stators comprising:
forming a plurality of partial windings on a plurality of stator cores, each stator core having a plurality of slots, each partial winding including a plurality of conductors arranged in the slots, the plurality of conductors forming a crown at one end of the stator core and including (i) a first plurality of conductors positioned in the slots and defining a standard crown height, and (ii) a second plurality of conductors extending beyond the standard crown height at the one end of the stator core, the second plurality of conductors including open ends;
completing a first winding of the plurality of partial windings on a first stator core by making first connections between the open ends of the second plurality of conductors such that the first winding is a multi-phase winding with a first number of parallel paths per phase; and
completing a second winding of the plurality of partial windings on a second stator core by making second connections between the open ends of the second plurality of such that the second winding is a multi-phase winding with a second number of parallel paths per phase, the second number different than the first number.

17. The method of claim 16 wherein the first number is four and the second number is six.

18. The method of claim 16 wherein the first connections are welds between adjacent leg ends of the second plurality of conductors.

19. The method of claim 16 wherein each of the second connections are bus bar connections extending between two distant leg ends of the second plurality of conductors.

20. The method of claim 16 wherein the plurality of conductors include a plurality of segmented conductors, wherein the open ends of the second plurality of conductors are extended leg ends positioned beyond the crown at the one end of the stator core, wherein the second plurality of conductors on the first stator core define a set of first conductor pairs that are connected together to form the first winding, and wherein the second plurality of conductors are on the second stator core define a set of second conductor pairs that are connected together to form the second winding.
